(19) United States
(12) Patent Application Publication
(10) Pub. No.: US 2016/0246602 A1
(43) Pub. Date: Aug. 25, 2016

(54) PATH SELECTION BASED ACCELERATION OF CONDITIONALS IN COARSE GRAIN RECONFIGURABLE ARRAYS (CGRAS)

(71) Applicants: Shri Hari Rajendran Radhika, Tempe, AZ (US); Aviral Shrivastava, Phoenix, AZ (US)

(72) Inventors: Shri Hari Rajendran Radhika, Tempe, AZ (US); Aviral Shrivastava, Phoenix, AZ (US)

(73) Assignee: ARIZONA BOARD OF REGENTS ON BEHALF OF ARIZONA STATE UNIVERSITY, Scottsdale, AZ (US)

(21) Appl. No.: 15/048,680

(22) Filed: Feb. 19, 2016

Related U.S. Application Data
(60) Provisional application No. 62/118,383, filed on Feb. 19, 2015.

(51) Int. Cl. G06F 9/30; G06F 9/38

(52) U.S. Cl. CPC G06F 9/30058; G06F 9/3802; G06F 9/3836

(57) ABSTRACT

The present invention discloses a solution to accelerate control flow loops by utilizing the branch outcome. The embodiments of the invention eliminate fetching and execution of unnecessary operations and also the overhead due to predicate communication thus overcoming the inefficiencies associated with existing techniques. Experiments on several benchmarks are also disclosed, demonstrating that the present invention achieves optimal acceleration with minimum hardware overhead.

### CROSS-REFERENCE TO RELATED APPLICATIONS

This application claims priority to U.S. Provisional Application No. 62/118,383 filed Feb. 19, 2015, which is specifically incorporated herein by reference without disclaimer.

### FIELD OF THE INVENTION

The present invention relates generally to the field of computer hardware accelerators. More particularly, it concerns coarse grain reconfigurable array accelerator performance and efficiency.

### BACKGROUND OF THE INVENTION

1. Summary of the Prior Art

Accelerators are now widely accepted as an inseparable part of computing fabric. Special purpose, custom hardware accelerators have been shown to achieve the highest performance with the least power consumption (Chung & Milder, 2010). However, they are not programmable and incur a high design cost. On the other hand Graphics Processing Units or GPUs, although programmable, are limited to accelerating only parallel loops (Betkaoui, 2010). Field Programmable Gate Arrays (FPGAs) have some of the advantages of hardware accelerators and are also programmable (Che, et al., 2008). However, their fine-grain re-configurability incurs a very high cost in terms of energy efficiency (Theodoridis, et al., 2007).

Coarse Grain Reconfigurable Arrays (CGRAs) are programmable accelerators that promise high performance at low power consumption (A. C., et al., 2007). The ADRES CGRA (F. B., et al., 2008) has been shown to achieve performance and power efficiency of up to 60 GOPS/W @ 90 nm technology node. Some CGRAs are an array of processing elements (PE) which are connected with each other through an interconnection network, such as the CGRA 100 shown in FIG. 1. PEs (e.g., 110) usually consists of a functional unit (e.g., 114), local register files (e.g., 122) and output register (e.g., 126). The functional unit typically performs arithmetic, logic, shift and comparison operations. Within a CGRA, the operands for each PE can be obtained from (i) neighboring PEs (e.g., PE 134 and PE 110 transmit operands via connection 134), (ii) a PE's own output from a previous cycle (not shown), or (iii) a data bus (e.g., bus 138) or the local register file (e.g., 122). Every cycle, instructions are issued to all PEs specifying the operation and the position of input operands. CGRAs are more power-efficient than FPGAs, since they are programmable at a coarser granularity—at the level of arithmetic operations—in contrast to FPGAs which are programmable at the bit level. Since CGRAs support both parallel and pipelined execution, they can accelerate both parallel and non-parallel loops (De Sutter, 2013)—as opposed to GPUs that can only accelerate parallel loops.

One of the major challenges associated with CGRAs is that of accelerating loops with if-then-else structures. Hamzeh et al., 2014 show that it is important to accelerate loops with if-then-else constructs because many long running loops in important applications have if-then-else constructs. Since the result of the conditional is known only at run time, existing solutions handle loops with if-then-else in CGRAs by predication (Mahlke & Lin; Mahlke, 1995; Han, et al., 2013; Chan & Choi, 2008). The partial predication and full predication schemes, for example, execute code in the “if” block and the “else” block of an if-then-else and then selects which branch outputs to use later. These techniques execute instructions from both the paths of an if-then-else structure and then commit the results of only the instructions from the path taken by the branch at run time. While predication allows for correct execution, it results in doubling the resource usage—and therefore inefficient execution. Dual-issue schemes (Han, et al., 2010; Han, et al., 2013; Hamzeh, et al., 2014) try to improve this by fetching the instructions from both paths but only executing instructions from the correct path. They achieve higher performance and efficiency, but at the cost of increased instruction fetch bandwidth—they have to fetch 2 instructions per PE every cycle.

2. Background and Related Work

Loop kernels are the most desirable parts of the program to be accelerated in a CGRA (Rau, et al., 1994). Most of the computational loop kernels have if-then-else structures in them (Hamzeh, et al., 2014), hence accelerating such loops is important to have an effective loop acceleration in CGRAs. Consider loop kernel 200 and 200a with if-then-else structures as shown in FIGS. 2A and 2C, respectively. The kernel has 5 predicate based instructions, two in the if-block and three in the else-block, illustrated in the expanded version of kernel 200 from FIG. 2A in kernel 200a of FIG. 2C. The variable c[i] is updated in both blocks 204 and 208 (also, 204a and 208a), so updating c[i] must be conditional depending on the branch taken at run time. Variables yₜ and x_{f}, y_{f} are intermediate variables used for the computation of cₜ and c_{f} in the if-block 204 and else-block 208, respectively, as shown by 204a and 208a. There are three commonly used techniques to execute kernels with if-else structures in CGRAs: i) Partial predication, ii) Full predication, and iii) Dual issue, illustrated in CGRA 224 containing PEs 251, 252, 253, and 254 at each iteration of the kernel loop in FIGS. 2E, 2G, and 2I, respectively. FIG. 2B illustrates how PEs 251-254 are interconnected in the exemplary CGRA 224.

In a partial predication scheme (Han, et al., 2013; Mahlke, et al., 1992), the if-path 204a and else-path 208a operations of a conditional branch are executed in parallel in different PE resources. The final result of an output is selected (e.g., select 212) between outputs of two paths based on the outcome of the conditional operation (predicate value, S). This is illustrated in data flow graph 220a in FIG. 2D. This is accomplished by a select instruction which acts like a hardware multiplexer or a phi operation in compilers. The diamond shaped node 212a represents the select operation 212 for the variable c[i]. A PE template for a partial predication scheme is shown in FIG. 1. There is a predicate mux 142 selecting a predicate value available from the neighboring PEs or from the predicate register file 146 or the predicate value generated by the PE in previous cycle. Predicate communication is done via a predicate register and a predication network. FIG. 2E shows how the loop kernel 200 and 200a can be executed via a partial predication scheme in CGRA 224. The metric of performance is the Initiation Interval (II) 228, which is the number of cycles after which the next iteration can be started. The lowest possible II is desired. II 228 is 3 for the partial prediction scheme illustrated in FIG. 2E.

In a full predication scheme (Han & C., et al., 2013; Han, et al., 2013), the output of false path operations are suppressed based on a predicate bit (0 for false path operations). Operations that update the same variable have to be mapped to the same PE albeit at different cycles. FIG. 2F illustrates DFG 220b for kernel 200 and 200a for mapping a full predication scheme to CGRA 224. FIG. 2G shows that operations cₜ and c_{f} are mapped to the same PE (PE 251) at cycles 4 and 5, respectively, which has the predicate value. The correct value is available in the register of the PE (PE 251) after the execution of operations from both paths is past or as illustrated in PE 251 FIG. 2G, at iteration 6. This eliminates the need for select instructions. Hardware support requires a predicate enabled PE output. The full prediction scheme illustrated in FIG. 2G has an II 232 of 5.

In a dual-issue scheme (Han, et al., 2013), each PE receives two instructions, one from the if-path and the other from else-path at each cycle. At run-time, the PE executes only one of the instructions based on the predicate bit. Since an operation from the false path is not executed, a select operation is not required. Operations in the different paths producing the same output (e.g., cₜ and c_{f}) are merged together to execute on the same PE, as illustrated, for example by PE 254 at iteration 3 in FIG. 2I. Nodes that have 2 instructions associated with them are called merged nodes, as shown by octagons (e.g., PE 251 at iteration 3 and PE 254 at iterations 1, 3, and 4) in FIG. 2I. Merged nodes 236, 240, and 244 are also illustrated in DFG 220c for kernels 200 and 200a. In addition to the architectural support required for partial predication, supporting Dual issue requires a 2×1 mux (not shown) which selects either the if-path operation or the else-path operation to be executed by the PE. The dual issue scheme illustrated in FIG. 2F has an II 258 of 3.

3. Inefficiencies of Existing Techniques

The fundamental inefficiency of existing solutions in handling loops with control flow is that they do not utilize the knowledge of the branch outcome to reduce the overhead of branch execution—even after the branch outcome is known. For instance, the branch outcome is known at cycle 1 in the partial and full predication schemes (FIGS. 2D-2G). However, they still execute three unnecessary operations, x_{f}; y_{f} and c_{f}, if the condition evaluates to true, i.e., if branch 204 and 204a is true and the else path 208 and 208a is false. This blind-eye towards an important output and failure to use its result translates into excessive resource usage, lower performance and more dynamic power wasted. This limitation may be tolerable for if-then-else structures which have a relatively lower number of operations, but it becomes high for if-then-elses where the number of operations in the conditional path is large. Even though the dual-issue scheme does not execute the false path instructions it still fetches the instructions for the branch not taken—not utilizing the branch outcome even after it is known in cycle 1. For example, in FIG. 2I, instructions to calculate yₜ and y_{f} are fetched and mapped to PE 254 at cycle 3 even though only yₜ from the true branch (e.g., the if-branch 204 and 204a in this example) will be executed.

The other limitation of the existing approaches is that the predicate value must be communicated to the PEs executing the if-path and the else-path operation. This communication is done either by storing the predicate value in the internal register of a PE or through the predicate network via routing. The need for this communication results in restrictions on where the conditional operations can be mapped. For instance, in partial predication, the select operation, c, can be mapped only to PEs in which the corresponding predicate value is available, and in full predication scheme, the operations cₜ, and c_{f} should be mapped onto the same PE (e.g., PE 251 of FIG. 2G) where the predicate value is available. For dual issue scheme, the predicate value must be present in the internal register of the PEs executing merged nodes [symbol] nop, x_{f} [symbol] , [symbol] yₜ, y_{f} [symbol] and [symbol] cₜ, c_{f} [symbol] to select the right instruction. These restrictions in mapping conditional operations lead to poor resource utilization.

### SUMMARY OF THE INVENTION

Loops that contain if-then-elses may be accelerated by fetching and executing only the instructions from the path taken by a branch at run time. This may be accomplished by determining the outcome of the if-then-elses prior before instructions are issued to any PEs in a CGRA and using the calculated outcome of the if-then-elses to control whether or not an instruction is issued. This process avoids unnecessarily issuing instructions that will never be executed because they are in the unexecuted branches of the if-then-elses. Compared to partial predication or full predication schemes, this approach avoids both issuing instruction for the unexecuted branch and executing the instructions contained in the branch that does not get selected.

Some embodiment of the present invention contain two parts: (i) executing the branch condition as early as possible, and (ii) once the branch is computed, communicating its results to the Instruction Fetch Unit (IFU) of the CGRA, which then starts to fetch instructions from the correct path. Experimental results on accelerating loop kernels with if-then-else structures from biobench (Albayraktaroglu, et al., 2005) and SPEC (Henning, et al., 2006) benchmark using the present invention resulted in a 34.6%, 36%, 59.4% improvement in performance and a 52.1%, 35.5% and 53.1% lower energy consumption (CGRA power and power spent on instruction fetch operation) as compared to dual-issue technique (Hamzeh, et al., 2014), partial predication scheme (Han, et al., 2013) and full predication scheme (Han and C., et al., 2013), respectively.

Some embodiments of the present computer program product comprise a non-transitory computer readable medium comprising code for performing the steps of: receiving at least one function executed by a computer program; resolving a branching condition to produce an outcome wherein at least one path of the branch is to be executed by a coarse grain reconfigurable array and at least one path of the branch is false; executing the branch condition in at least one processing element of the Coarse Grain Reconfigurable Array and communicating the branch outcome to the Instruction Fetch Unit; and selectively issuing instructions from the instruction memory for the at least one path to be executed. In some embodiments the non-transitory computer readable medium comprises code and hardware components for performing the step of communicating the branching condition outcome and a number of cycles required to execute the at least one path to the instruction fetch unit. In some embodiments the non-transitory computer readable medium comprises code for performing the step of utilizing a delay slot after the step of resolving the branching condition outcome to communicate the branching condition outcome to the instruction fetch unit. In some embodiments the non-transitory computer readable medium comprises code for performing the step of performing operations that are independent of the branching condition outcome in the delay slot. In some embodiments the non-transitory computer readable medium comprises code for performing the step of mapping operations to processing elements in the coarse grain reconfigurable array from both an if-path of the branching condition and an else-path of the branching condition. In some embodiments the non-transitory computer readable medium comprises code for performing the step of pairing the mapped operations from the if-path and the else-path based on a common variable. In some embodiments the non-transitory computer readable medium comprises code for performing the step of pairing a no op instruction with an if-path instruction when the else-path contains fewer operations than the if-path. In some embodiments the non-transitory computer readable medium comprises code for performing the step of pairing a no op instruction with an else-path instruction when the if-path contains few operations than the else-path. In some embodiments the non-transitory computer readable medium comprises code for performing the step of eliminating a select instruction or a phi operation based on the pairing by the common variable and based on the step of communicating which of the at least one paths of the branching condition is to be executed to the instruction fetch unit.

Some embodiments of the present computer program product comprise a non-transitory computer readable medium comprising code for performing the steps of: receiving at least one function executed by a computer program; resolving a branching condition to produce an outcome wherein at least one path of the branch is to be executed by a coarse grain reconfigurable array and at least one path of the branch is false; executing the branch condition in at least one processing element of the Coarse Grain Reconfigurable Array and communicating the branch outcome to the Instruction Fetch Unit; and selectively issuing instructions from the instruction memory for the at least one path to be executed. In some embodiments the non-transitory computer readable medium comprises code and hardware components for performing the step of communicating the branching condition outcome and a number of cycles required to execute the at least one path to the instruction fetch unit. In some embodiments the non-transitory computer readable medium comprises code for performing the step of utilizing a delay slot after the step of resolving the branching condition outcome to communicate the branching condition outcome to the instruction fetch unit. In some embodiments the non-transitory computer readable medium comprises code for performing the step of performing operations that are independent of the branching condition outcome in the delay slot. In some embodiments the non-transitory computer readable medium comprises code for performing the step of mapping operations to processing elements in the coarse grain reconfigurable array from both an if-path of the branching condition and an else-path of the branching condition. In some embodiments the non-transitory computer readable medium comprises code for performing the step of pairing the mapped operations from the if-path and the else-path based on a common variable. In some embodiments the non-transitory computer readable medium comprises code for performing the step of pairing a no op instruction with an if-path instruction when the else-path contains fewer operations than the if-path. In some embodiments the non-transitory computer readable medium comprises code for performing the step of pairing a no op instruction with an else-path instruction when the if-path contains few operations than the else-path. In some embodiments the non-transitory computer readable medium comprises code for performing the step of eliminating a select instruction or a phi operation based on the pairing by the common variable and based on the step of communicating which of the at least one paths of the branching condition is to be executed to the instruction fetch unit.

Some embodiments of the present apparatuses comprise a memory; and a processor coupled to the memory, wherein the processor is configured to execute the steps of: receiving at least one function (e.g., loop kernel) executed by a computer program; resolving a branching condition to produce an outcome wherein at least one path of the branch is to be executed by a coarse grain reconfigurable array and at least one path of the branch is false; executing the branch condition in at least one processing element of the Coarse Grain Reconfigurable Array and communicating the branch outcome to the Instruction Fetch Unit; and selectively issuing instructions from the instruction memory for the at least one path to be executed. In some embodiments, the processor is further configured to execute the step of communicating the branching condition outcome and a number of cycles required to execute the at least one paths to the instruction fetch unit by minimum delay circuit components. In some embodiments, the processor is further configured to execute the step of utilizing a delay slot after the step of resolving the branching condition outcome to communicate the branching condition outcome to the instruction fetch unit. In some embodiments, the processor is further configured to execute the step of performing operations that are independent of the branching condition outcome in the delay slot. In some embodiments, the processor is further configured to execute the step of mapping operations to processing elements in the coarse grain reconfigurable array from both an if-path of the branching condition and an else-path of the branching condition. In some embodiments, the processor is further configured to execute the step of pairing the mapped operations from the if-path and the else-path based on a common variable. In some embodiments, the processor is further configured to execute the step of pairing a no op instruction with an if-path instruction when the else-path contains fewer operations than the if-path. In some embodiments, the processor is further configured to execute the step of pairing a no op instruction with an else-path instruction when the if-path contains few operations than the else-path. In some embodiments, the processor is further configured to execute the step of eliminating a select instruction or a phi operation based on the pairing by the common variable and based on the step of communicating which of the at least one paths of the branching condition is to be executed to the instruction fetch unit.

Some embodiments of the present methods comprise: receiving at least one function (e.g., loop kernel) executed by a computer program, wherein the function includes a branching condition; mapping at least two potential paths of the branching condition to at least one processing element in a coarse grain reconfigurable array by a compiler; resolving the branching condition to produce an outcome wherein at least one path of the branch is to be executed by a coarse grain reconfigurable array and at least one path of the branch is false; executing the branch condition in at least one processing element of the Coarse Grain Reconfigurable Array and communicating the branch outcome to the Instruction Fetch Unit; and selectively issuing instructions from the instruction memory for the at least one path to be executed.

Some embodiments of the present apparatuses comprise: a coarse grain reconfigurable array comprising at least two processing elements; an instruction fetch unit; at least one processing element configured to communicate a branch outcome to the instruction fetch unit; the branch outcome comprising at least a path to be taken; the instruction fetch unit further configured to issue instructions for the path taken. In some embodiments, at least one processing element (which also evaluates the branch condition) is configured to communicate a number of cycles required to execute the path to be taken to the instruction fetch unit.

As used herein the specification, “a” or “an” may mean one or more. As used herein in the claim(s), when used in conjunction with the word “comprising”, the words “a” or “an” may mean one or more than one.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” may mean at least a second or more.

Throughout this application, the term “about” is used to indicate that a value includes the inherent variation of error for the device, the method being employed to determine the value, or the variation that exists among the study subjects.

The foregoing has outlined rather broadly certain features and technical advantages of some embodiments of the disclosure in order that the detailed description that follows may be better understood. Additional features and advantages will be described hereinafter that form the subject of the claims. It should be appreciated by those having ordinary skill in the art that the specific embodiments disclosed may be readily utilized as a basis for modifying or designing other structures for carrying out the same or similar purposes. It should also be realized that such equivalent constructions do not depart from the spirit and scope of the invention as set forth in the appended claims. The novel features that are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the disclosure.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 illustrates a 4×4 CGRA with PEs connected in a torus interconnect found in prior art CGRAs. Each PE consists of an ALU and register files and receives an instruction each cycle to operate on available data.

FIG. 2A illustrates a simple loop kernel containing an if-then-else statement.

FIG. 2B illustrates an exemplary 2×2 CGRA containing four PEs with toroidal interconnectivity and predicate output registers.

FIG. 2C illustrates the simple loop kernel of FIG. 2A after Static Signal Assignment (SSA) transformation, where C represents constants available from the immediate field of an instruction to PE.

FIG. 2D is a Data Flow Graph (DFG) to perform partial predication scheme mapping of the transformed loop kernel of FIG. 2C.

FIG. 2E depicts the CGRA from FIG. 2B during four iterations of the loop kernel shown in FIGS. 2A and 2C with the DFG of FIG. 2D mapped onto different PEs of the CGRA.

FIG. 2F is a Data Flow Graph (DFG) to perform full predication scheme mapping of the transformed loop kernel of FIG. 2C.

FIG. 2G depicts the CGRA from FIG. 2B during six iterations of the loop kernel shown in FIGS. 2A and 2C with the DFG of FIG. 2F mapped onto different PEs of the CGRA.

FIG. 211 is a Data Flow Graph (DFG) to perform dual issue scheme mapping of the transformed loop kernel of FIG. 2C.

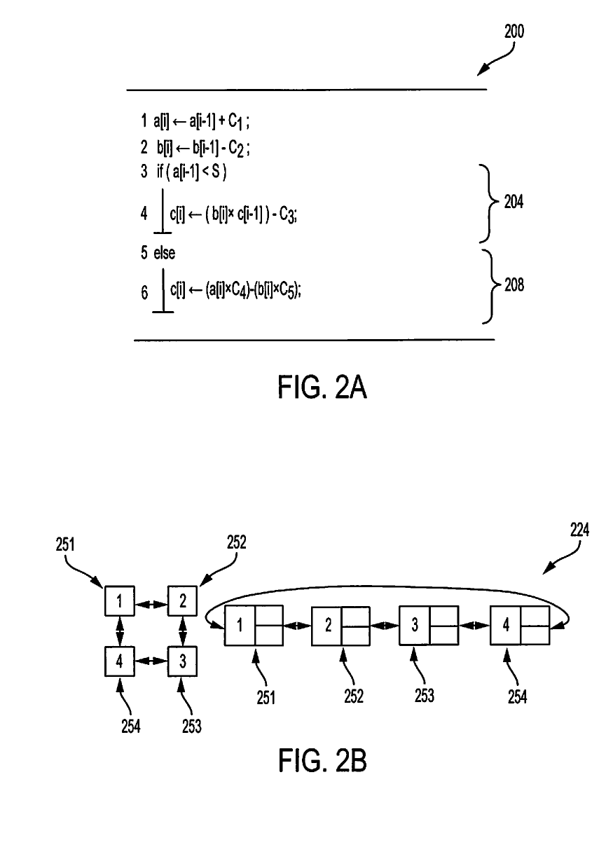

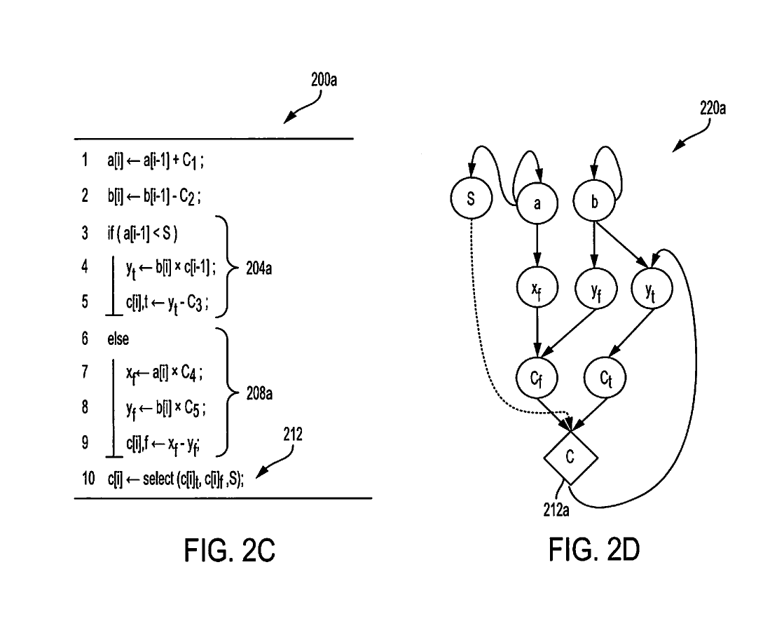

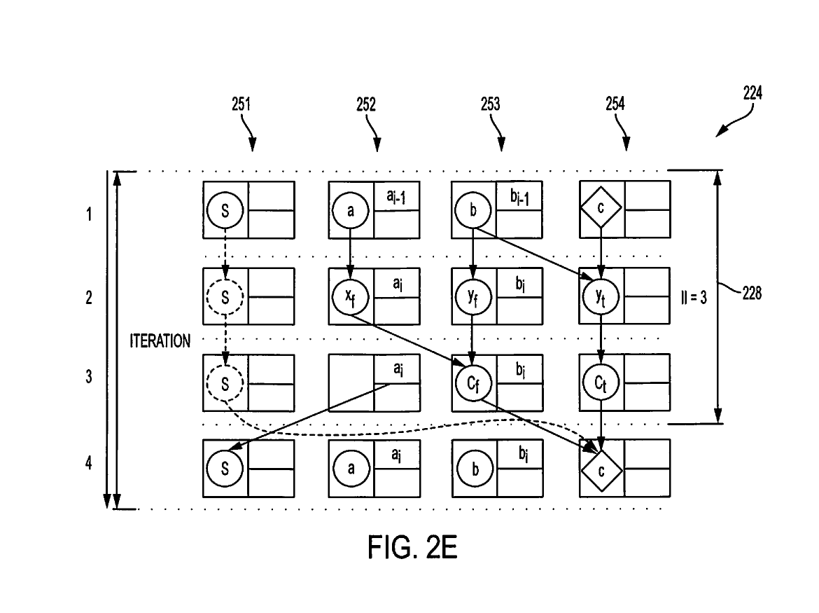

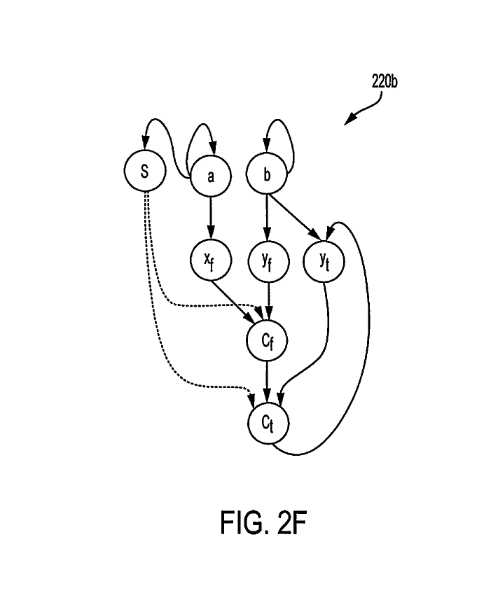

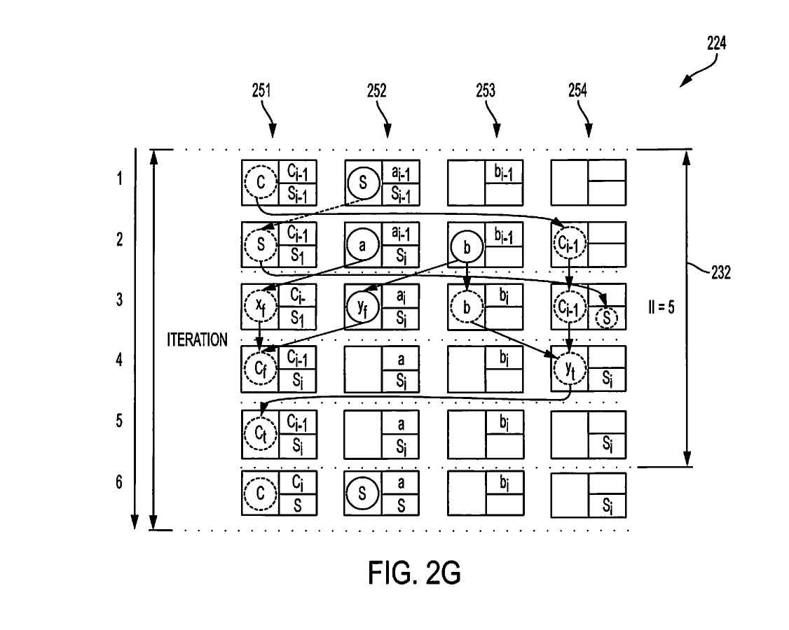

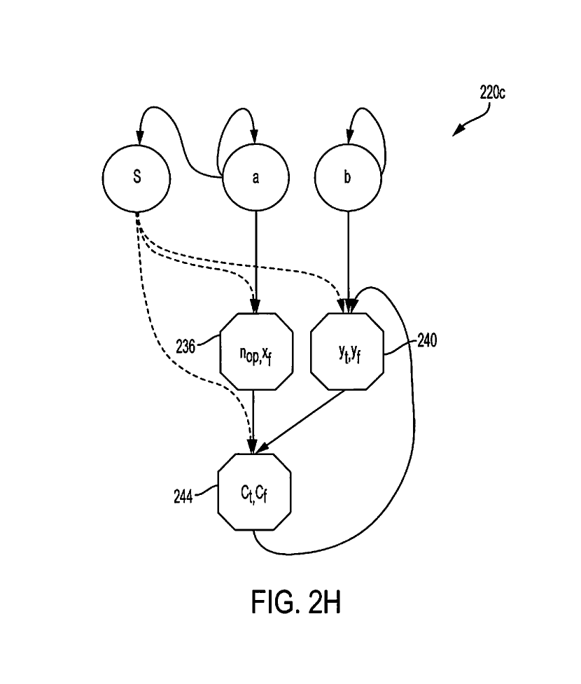

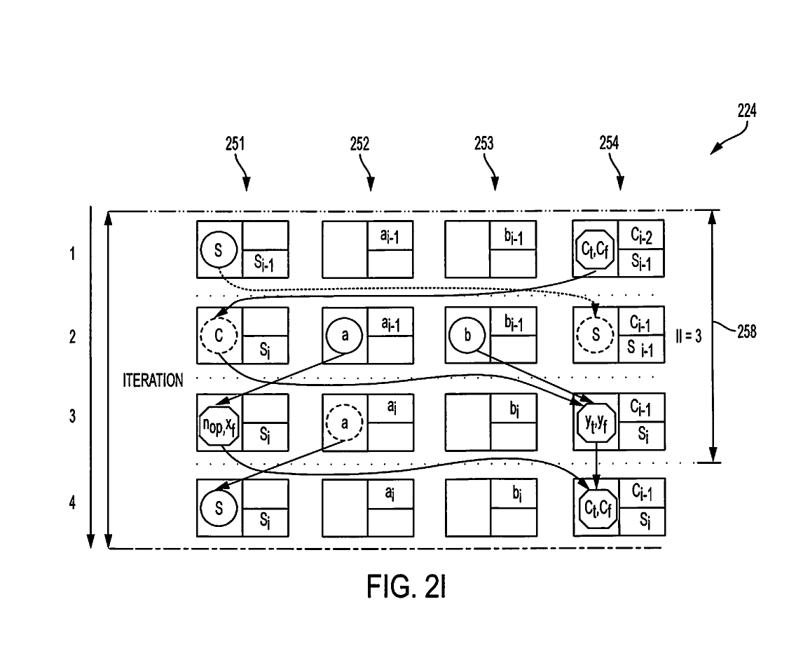

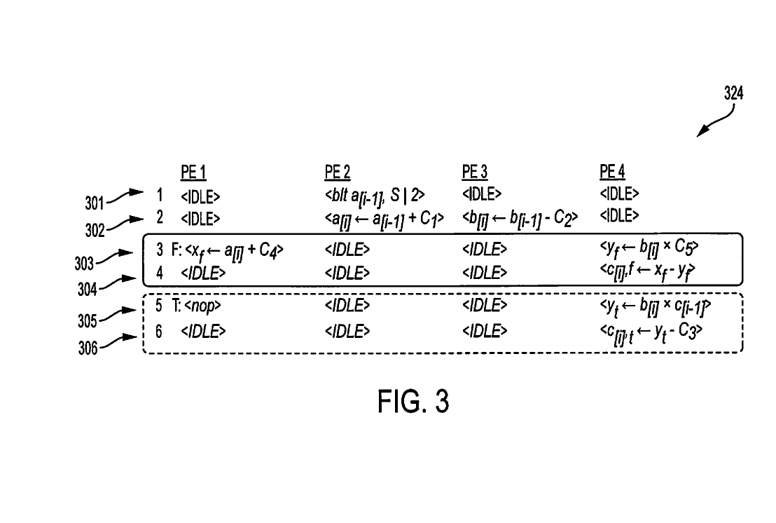

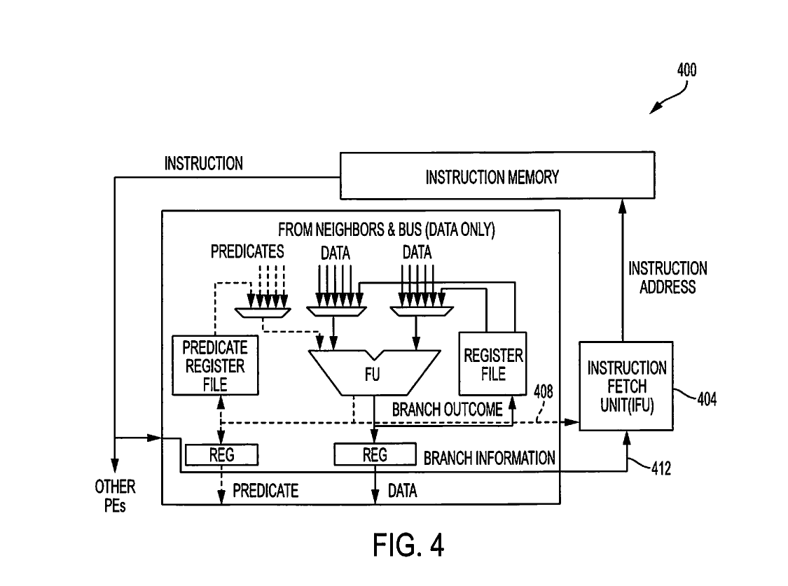

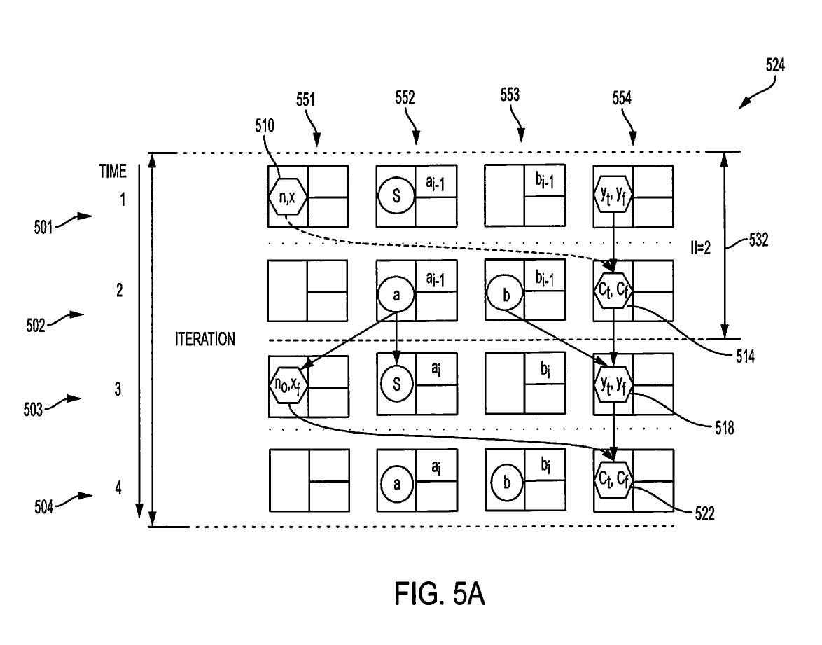

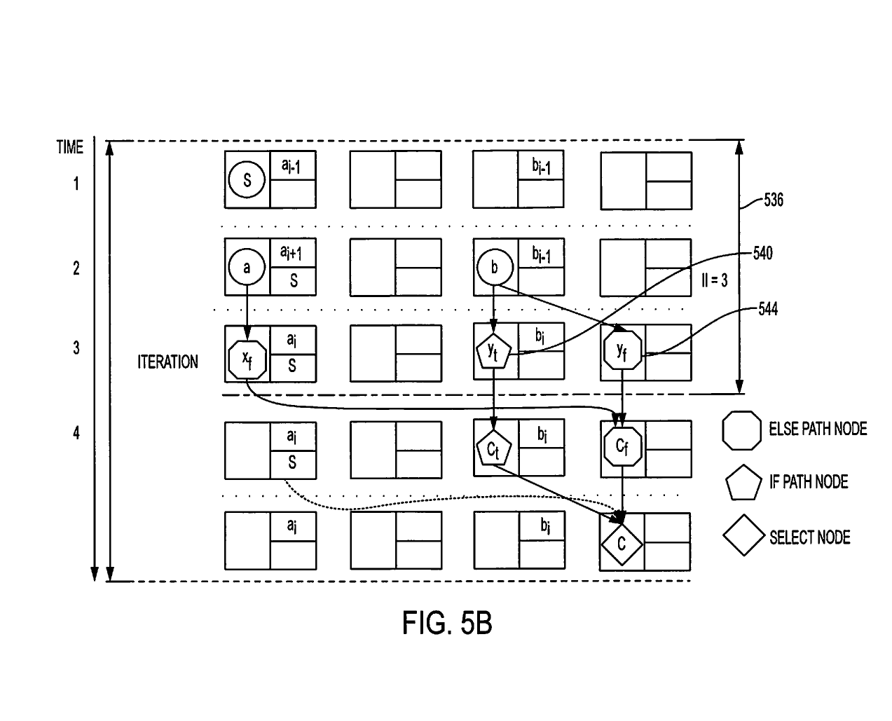

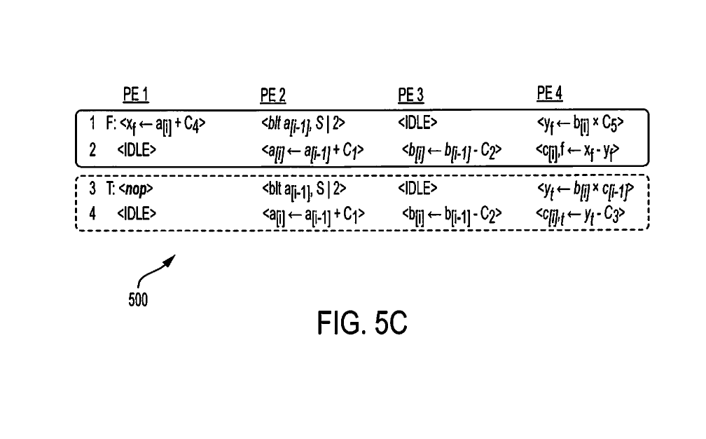

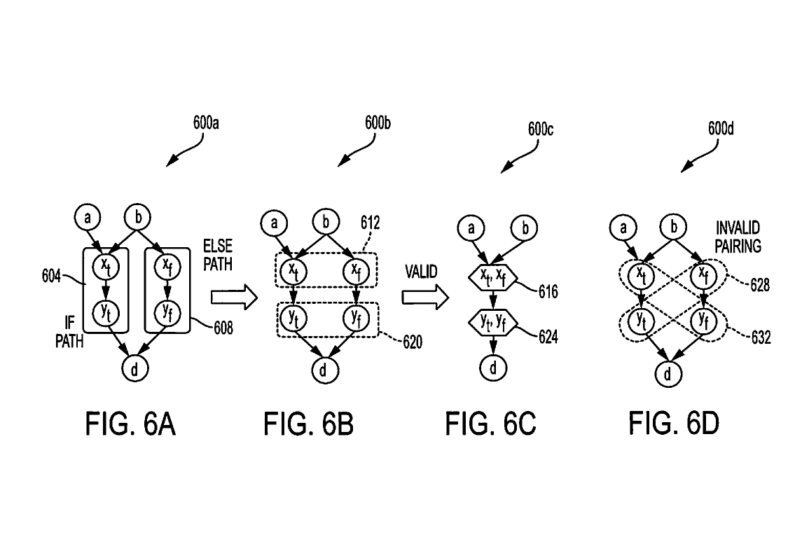

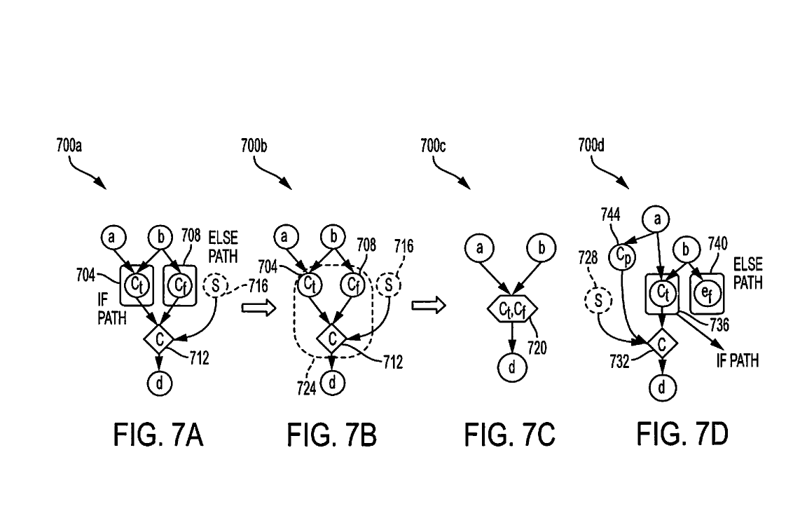

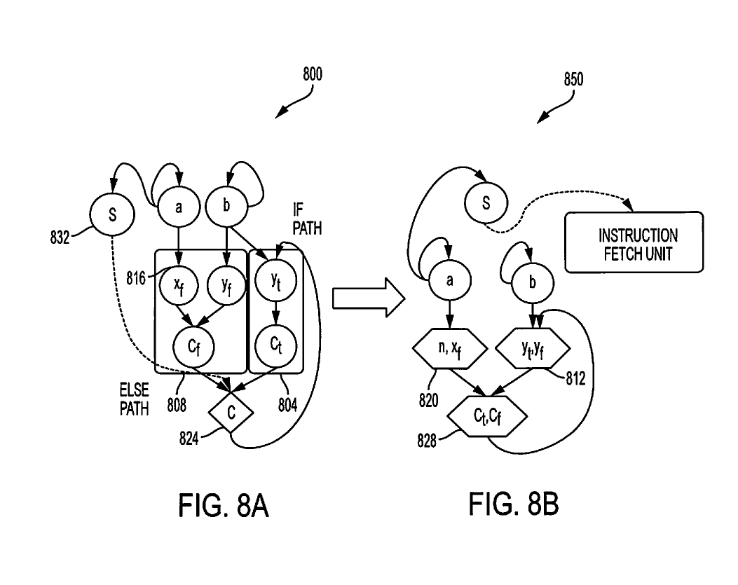

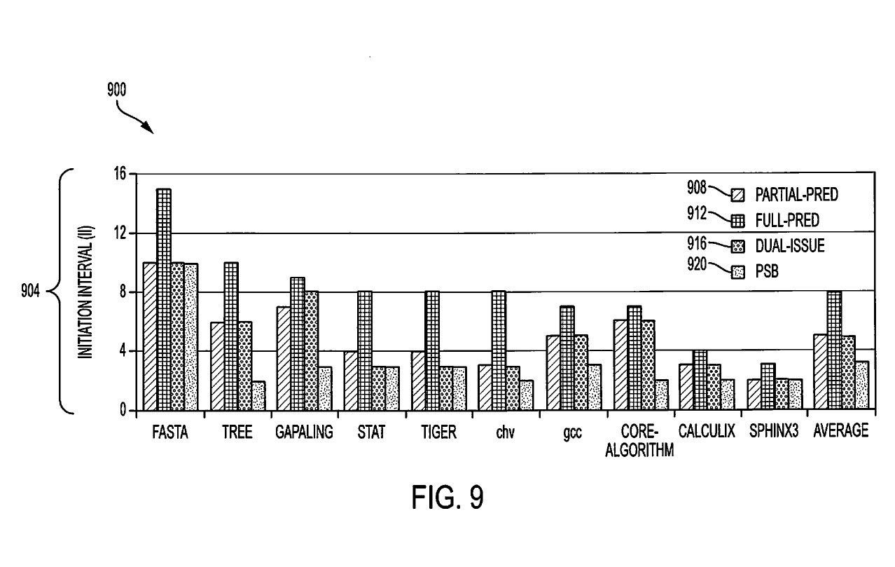

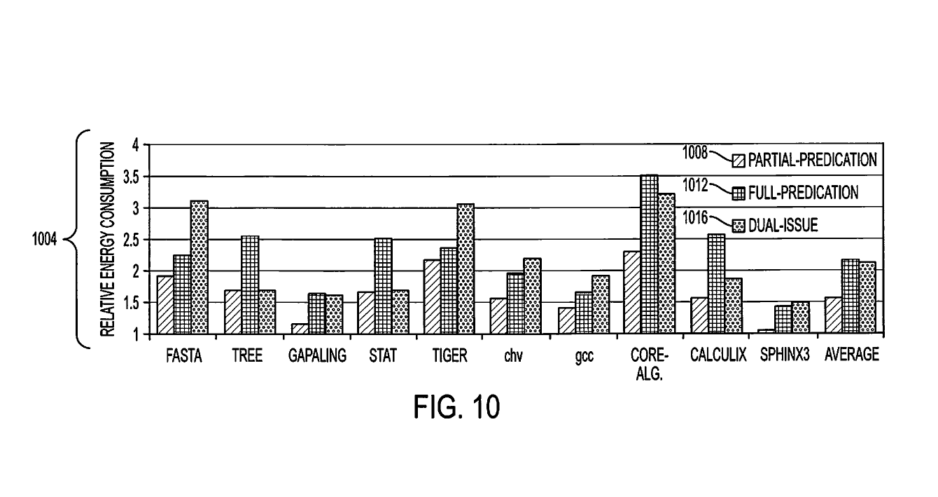

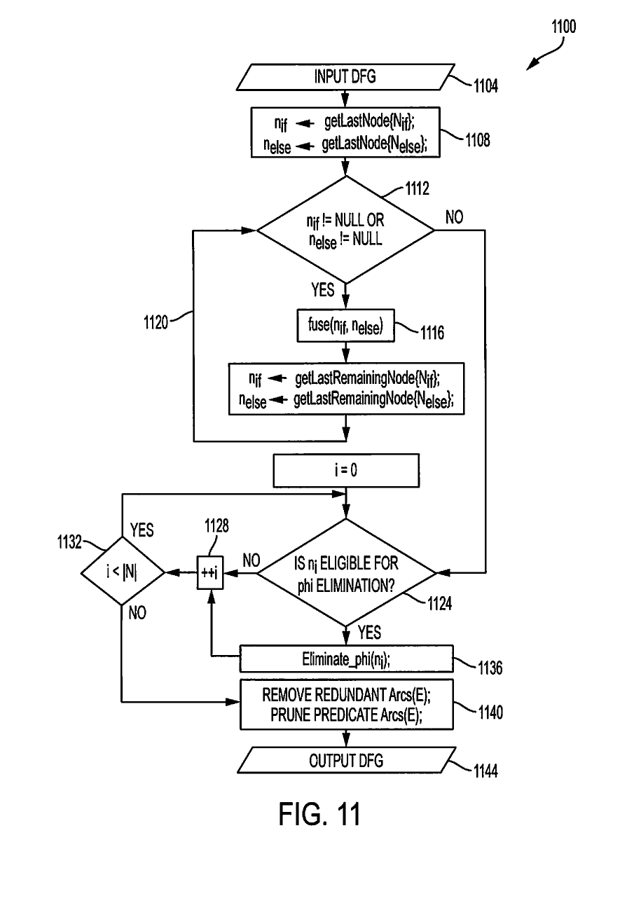

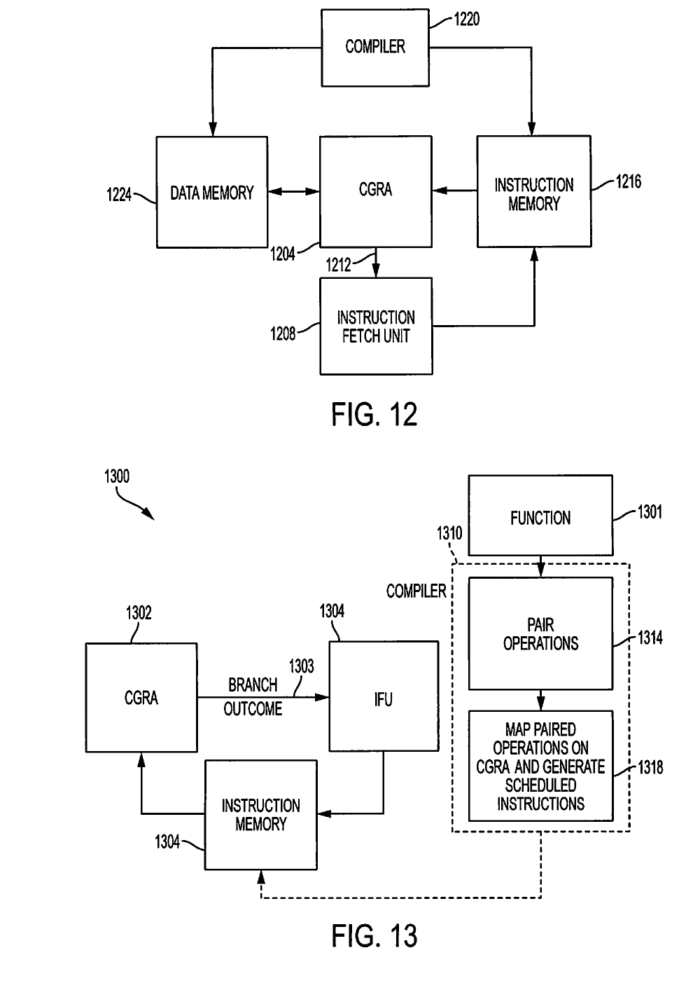

FIG. 2I depicts the CGRA from FIG. 2B during four iterations of the loop kernel shown in FIGS. 2A and 2C with the DFG of FIG. 2H mapped onto different PEs of the CGRA.

FIG. 3 illustrates an example of ordered code containing a set of if-path and else-path instructions.

FIG. 4 is an illustrative embodiment of hardware modifications to implement aspects of the present disclosure, namely communication of branch outcomes to an IFU for managing which instructions from a conditional statement are issued to PEs in a CGRA.

FIG. 5A illustrates an example of how a mapping with paired operations according to the present disclosure results in lower II when compared to other methods, such as the method shown in FIG. 5B.

FIG. 5B illustrates n example of how a mapping operations without pairing results in poor resource utilization (higher II).

FIG. 5C contains the sample code instructions used in the code mappings of FIG. 5A after pairing and modulo scheduling.

FIGS. 6A-6C illustrate an example DFG with available valid pairings. The transformation from a standard DFG to a DFG with fused nodes containing proper pairings according to one embodiment of the present disclosure is illustrated in the transitions between FIGS. 6A, 6B, and 6C.

FIG. 6D illustrates an invalid pairing of the DFG from FIG. 6A where the suggested pairing fails to meet the criteria for validity and feasible scheduling.

FIGS. 7A-7C illustrate an example of a DFG containing a select/phi operation that may be removed according to some embodiments of the present disclosure where the select/phi operation contains inputs from if-path and else-path.

FIG. 7D shows an alternative example of a DFG where select/phi operation removal is not possible because the input to the select/phi operation do not belong to the set of if or else-path operations.

FIGS. 8A and 8B illustrate another example of a DFG being transformed into a DFG with fused nodes to be mapped to a CGRA in accordance with some embodiments of the present disclosure.

FIG. 9 is a bar graph of experimental results comparing a modeled 4×4 CGRA's performance of compiled loops using i) Partial Predication, ii) Full Predication, iii) Dual-Issue, and iv) the present disclosure's PSB technique. PSB achieved the lowest II. Resource utilization and performance are inversely proportional to II.

FIG. 10 is another bar graph of model results showing the relative energy consumption of prior art techniques according to several benchmarks where the three techniques charted have been normalized against energy consumption using one embodiment of the present disclosure. Thus, the embodiment tested is not shown as a separate bar because performance parity to the tested embodiment is signified as 1 on the y-axis of relative energy consumption.

FIG. 11 illustrates a heuristic of one embodiment of the present disclosure that may be implemented in an LLVM compiler.

FIG. 12 is a block diagram showing the functional relationships between hardware components supporting a CGRA in some embodiments of the present disclosure.

FIG. 13 is a block diagram of another embodiment of the present disclosure illustrating the relationships between hardware components and certain methods of the present disclosure that may be performed in a compiler.

### DESCRIPTION OF ILLUSTRATIVE EMBODIMENTS

Considering that only one path is taken at run time for the if-then-else construct, some embodiments of the present methods, systems, and apparatuses communicate the predicate (result of the branch instruction) to the instruction fetch Unit (IFU) of the CGRA, to selectively issue instructions only from the path taken by the branch at runtime, described herein as the Path Selection based Branch (PSB) technique.

FIG. 3 shows an exemplary arrangement of instructions of the loop body from FIG. 2C mapped to be executed on a 2×2 CGRA 324 using the present PSB technique. In the first cycle (i.e., when line 301 is executed), the branch operation [symbol] blt a[i−1], S|2 [symbol] is executed on PE 2 while the rest of the PEs are idle. The operation [symbol] blt a, b|K [symbol] is a branch instruction that compares if a<b. K is the maximum number of cycles required to execute the if-path or the else-path. In the example shown, the else-path is composed of instructions at addresses 3 and 4 (e.g., lines 303 and 304), and it takes 2 cycles to execute. The if-path also takes 2 cycles, and is composed of instructions at addresses 5 and 6 (e.g., lines 305 and 306). Even though the condition in the branch operation executes in cycle 1 (i.e., when line 301 is executed), the operations in the if-path or else-path does not begin execution until cycle 3. Cycle 2 is the delay slot of the CGRA, illustrated by code on line 302, in which the operations independent of the current branch outcome can be executed. This delay slot cycle is used to communicate the branch outcome to the IFU 404 (illustrated, for example, in FIG. 4). Operations [symbol] a [i]=a [i−1]+C1 [symbol] and [symbol] b [i]=b [1-1]−C2 [symbol] (e.g., line 302) executed on PEs 2 and 3 in the delay slot in cycle 2. After the delay slot the Instruction Fetch Unit (IFU) will start issuing instructions from the path taken by the branch. If the else-path is taken, then instructions 3 and 4 at lines 303 and 304 will be issued. After executing else-path instructions, the IFU will skip the next K instructions (e.g., skip lines 305 and 306 for the if-path), and start issuing instructions after that. If the if-path is taken, then the IFU will skip K instructions (e.g., skip lines 303 and 304 for the else-path) and start issuing if-path instructions (e.g., lines 305 and 306).

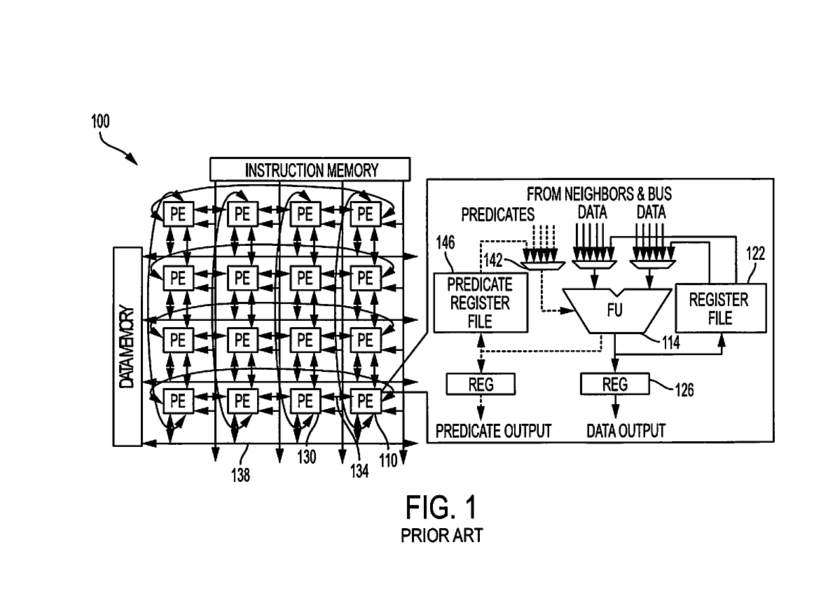

According to one embodiment of the disclosure, for branch outcome based issuing of instructions, additional hardware support may be used such as that shown in FIG. 4. In the illustrated embodiment, the architecture 400 of a partial predication scheme is modified to communicate the branch outcome 408 to the CGRA's (e.g., CGRA 224 of FIG. 2B or CGRA 100 of FIG. 1) IFU along with the information of number of cycles 412 to execute the branch. IFU 404 may be modified to issue instructions from the path taken based on branch information (e.g., outcome 408+number of cycles for conditional path 412).

Some embodiments may also include a compiler that maps operations from the loop kernel (including if-path, else-path and select or phi operations) onto the PEs of the time-extended CGRA 524 (similar to the time extended illustration of the 2×2 CGRA illustrated in FIG. 3). The PEs required to map the if-then-else portion of the loop kernel may be the union of the PEs on which the operations from the if-path and the else-path are mapped. Because only one of the paths is taken at runtime, some embodiments map the operations from the if-path and the operations from the else-path to the same PEs so that the number of PEs used to map the if-then-else is equal to the maximum of the number of PEs required to map either path's operations, as shown in FIG. 5A. Some forms of the present compiler map the code example 500 in FIG. 5C to nodes on the CGRA 524 shown in FIG. 5A. In the example shown in 5A, variables with a t subscript involve if-path instructions and variables with an f subscript involve and else-path instruction. Moreover, where two variables are mapped to the same PE, such as PE 551 at time 501 containing node 510, the first variable in the node (e.g., n) corresponds to the if-path and the second variable in the node (e.g., x) corresponds to the else-path. The compiler may perform a virtual mapping of each of the instructions to each PE, placing two instructions—one from the if-path and one from the else-path—to the same PE, even though a PE may only execute one instruction per clock cycle. The compiler may do this because the instructions will not actually be fetched and loaded into the PE until the branch has been determined, at which point the IFU will ignore the compiler's mapping of the unused branch instructions. By having the instructions already virtually mapped by the compiler though, the PEs are ready to run an instruction immediately after the branch outcome is determined. Hence, irrespective of the path taken by a branch, the PEs that are allocated paired operations from the if-path and the else-path execute a useful operation from the path taken.

The result is a better utilization of PE resources and more PEs being available to map operations from adjacent iterations to facilitate the use of a modulo scheduling scheme to further improve the performance. Comparing this to a prior art system where if-path and else-path operations are mapped onto different PEs, such as that shown in FIG. 5B, the PEs mapped with if-path operations will be inactive when the else-path executes and vice-versa. For example, in FIG. 5A, the compiler mapped cₜ and c_{f} to node 514 while a prior art compiler would map cₜ and c_{f} to separate PEs or the same PE at different cycles, taking up two clock cycles of processing power as shown in nodes 540 and 544 in FIG. 5B. In CGRAs where the PEs are reserved for each variable such as that shown in FIG. 5B, the PEs allocated to execute the operations in the conditional path is the sum of the PEs required for the if-path operations and else-path operations. But at run time only the PEs which were mapped with operations from the path taken are active and PEs associated with the false path are inactive, resulting in poor resource utilization and hence poor performance (i.e., a higher II 536 as illustrated by FIG. 5B, which has an II of 3 compared to II 532 of 2 in FIG. 5A).

Hence, by pairing operations from the if-path and from the else-path to form a fused node, e.g., nodes 510, 514, 518, and 522 in FIG. 5A mapping variables from code 500 of FIG. 5C, and mapping them to a CGRA via a modulo scheduling scheme, the example illustrated in FIG. 5A achieves a lower II 532 of 2, which outperforms the prior art. Therefore pairing the operations as described above yielded better performance and resource utilization.

### B. Problem Formation

Since pairing of operations from the if-path and the else-path results in improved resource utilization and performance, some embodiments address obtaining a valid pairing of operations. The pairing may ensure the correct functionality of the loop kernel. The problem of optimal pairing may be formulated as finding a transformation T(D)=P from the input Data Flow Graph (DFG): D=(N,E) to an output DFG: P(M,R) with fused nodes, with the objective of minimizing |M| (N and M represent the set of nodes in D and P) while retaining the correct functionality. The description below explains one embodiment of compiler techniques or problem formation that may be used in accordance with the present techniques to optimize PE utilization and performance in a CGRA.

Input:

DFG: D=(N, E) may be a data flow graph that represents the loop kernel to be processed, where the set of vertices N are the operations in the loop kernel, and for any two vertices, u, vεN, e=(u,v)εE if and only if the operation corresponding to v is data dependent or predicate dependent on the operation u. For a loop with control flow N={N_{if}∪Nₑₗₛₑ∪Nₒₜₕₑᵣ} where {N_{if}} is the set of nodes representing the operations in the if-path and likewise {Nₑₗₛₑ} for the else-path. Nₒₜₕₑᵣ is the set of nodes representing operations not in the if-path or the else-path and includes select operations.

Output:

DFG: P=(M, R): Where M may be the set of nodes in the transformed DFG representing the operations in the loop kernel with M=M{M_{fused}∪Mₒₜₕₑᵣ}. The nodes M_{fused} represent the fused nodes. In some embodiments, each fused node mεM_{fused} may be a tuple m= [symbol] m_{if}, mₑₗₛₑ [symbol] , where m_{if}εN_{if}∪{nop} and mₑₗₛₑεNₑₗₛₑ∪{nop}. For nodes x, yεM fused, r=(x, y)εR if and only if there is an edge e_{if}=(x_{if}, y_{if})εE or an edge eₑₗₛₑ=(xₑₗₛₑ, yₑₗₛₑ)εE. For some nodes xₒₜₕₑᵣεMₒₜₕₑᵣ, yεM_{fused}; r=(xₒₜₕₑᵣ,y)εR if and only if there is an edge e_{if}=(xₒₜₕₑᵣ, y_{if})εE or an edge eₑₗₛₑ=(xₒₜₕₑᵣ, yₑₗₛₑ)εE where xₒₜₕₑᵣεNₒₜₕₑᵣ. For nodes xεM_{fused}, yₒₜₕₑᵣεMₒₜₕₑᵣ, r=(x, yₒₜₕₑᵣ)εR if and only if there is an edge e_{if}=(x_{if}, yₒₜₕₑᵣ)εE or an edge eₑₗₛₑ=(xₑₗₛₑ, yₒₜₕₑᵣ)εE where yₒₜₕₑᵣεNₒₜₕₑᵣ.

Valid Output:

The output DFG P obtained after transformation is valid if and only if for two vertices x, y with x=(x_{if}, xₑₗₛₑ); y=(y_{if}, yₑₗₛₑ)εM_{fused} and r=(x, y)εR then if there is a path from x_{if} to y_{if} then there is no path (intra-iteration) from yₑₗₛₑ to xₑₗₛₑ and if there is a path from xₑₗₛₑ to yₑₗₛₑ there is no path (intra-iteration) from y_{if} to x_{if} originally in the input DFG. However, recurrence paths satisfying inter iteration dependencies are valid. FIGS. 6A-6D illustrate how some compiler embodiments may pair the instructions from DFG 600a of sample code. In DFG 600a, instruction set 604 contains exemplary if-path instructions and instructions set 608 contains exemplary else-path instructions. Some embodiments of the present compilers would notice the parallel calculations 612 of xₜ and x_{f} to create fused node 616, transforming the DFG 600b of 6B into the DFG 600c of FIG. 6C. Similarly, parallel calculations 620 of yₜ and y_{f} may be combined to create fused node 624. FIG. 6D illustrates an invalid pairings 628 and 632 in DFG 600d where the pairings may cause processing delays because instructions are fused in a mixed order.

Optimization:

Some embodiments seek to minimize |M| under constraints of a valid output. |M_{fused}| can be minimized by minimizing number of nops used to make a pair. |Mₒₜₕₑᵣ| can be minimized by eliminating the eligible select or phi operations that belong to Nₒₜₕₑᵣ.

1) Select/Phi Operation Elimination:

A select operation is used to select an output of a variable updated in both paths. If the if-path operation and the else-path operation updating the same variable are paired to form a fused node, there is no need for a select operation since at run time only one of the operations is executed; the output of the fused node has the right value after execution. For example, DFG 700a in FIG. 7A contains if-path 704 and else-path 708 that output to fused node 712. Because select operation 716 takes the value of node 712 after both the if-path 704 and the else-path 708, the overall program flow of DFG 700a is unaffected by fusing nodes 704, 708, and 712 to create a combined node 720 that removes the select operation and node 712. FIG. 7B illustrates DFG 700b with the nodes 704, 708, and 712 that are combined (combinable nodes 724) by a compiler to form node 720 in FIG. 7C. FIG. 7D, on the other hand, illustrates a situation where some embodiments may not be able to remove the phi/select operation 728 because the input of select operation 728, node 732, does not belong strictly to outputs of if-path 736 or else-path 740. Thus, removing select operation 728 or fusing node 732 with the paths 736 or 740 would break the relationship between the select operation and 744.

In summary, to improve performance and energy efficiency, the present invention utilizes the branch outcome to issue instructions only from the path taken. This eliminates fetching and execution of unnecessary operations and the need for predicate communication hence overcoming the inefficiencies associated with existing techniques.

### C. Illustrative Heuristic

The process of creating a DFG from CFG (Control Flow Graph) of a loop is presented in (Johnson & Pingali, 1993). The operations from the if-path and else-path form the set of operations N_{if} and Nₑₗₛₑ respectively. The algorithm for forming the DFG with fused node is shown in Algorithm 1. According to one embodiment of the disclosure, FIGS. 8A and 8B demonstrate how the kernel illustrated in FIG. 2C can be transformed using PSB. The algorithm starts by pairing operations of DFG 800 from if-path 804 and else-path 808. Pairing starts from the terminating operations cₜ and c_{f} in the if-path and the else-path respectively, based on lines 1 and 2 in Algorithm 1. Then the pairing proceeds iteratively in a partial order of operations as long as there are unpaired operations in the if-path and the else-path. This partial order is according to the dependence flow of the operations in the if-block and the else-block of the CFG. Node 812 containing [symbol] yₜ, y_{f} [symbol] represents a resulting fused node after iterative pairing. If the operations in the if-path and the else-path are unbalanced, unbalanced operations are paired with a nop. See, e.g., lines 7 and 9 in Algorithm 1. Hence, the unpaired else-path operation 816 containing x_{f} is paired with a nop to form a fused node 820 containing [symbol] nop, x_{f} [symbol] . After all operations in the if-path and the else-path are paired, eligible select operations are eliminated via a phi elimination pass, like the pass described in line 14 in Algorithm 1. In this example, the phi operation 824 containing c is eligible for elimination and the output of the fused node 828 [symbol] cₜ, c_{f} [symbol] serves as the output of the eliminated phi node. According to one embodiment of the disclosure, the redundant edges are then eliminated and predicate arcs are pruned and final output DFG 850 is obtained as shown in FIG. 8B. The DFG is given as an input to any mapping algorithm that can accommodate the delay slot to find a valid mapping. The delay slot is required to schedule the fused nodes with 1 cycle delay after the branch operation. FIG. 5A shows a valid mapping of the DFG with modulo scheduling according to one embodiment of the disclosure. The achieved II (e.g., 532 in FIG. 5A) of 2 is the lowest among all other techniques.

Algorithm 1: PSB (Input DFG(D), Output DFG(P))

| 1 | n_{if} ← getLastNode({N_{if}}); | |
|---|---|---|
| 2 | nₑₗₛₑ ← getLastNode({Nₑₗₛₑ}); | |
| 3 | while (n_{if} ≠ NULL or nₑₗₛₑ ≠ NULL) do | |
| 4 | \| | if n_{if} ∈ N_{if} and nₑₗₛₑ ∈ Nₑₗₛₑ then |
| 5 | \| | \|_ fuse(n_{if}, nₑₗₛₑ); |
| 6 | \| | else if n_{if} ∈ N_{if} and nₑₗₛₑ == NULL then |
| 7 | \| | \|_ fuse(n_{if}, nop); |
| 8 | \| | else if n_{if} == NULL and nₑₗₛₑ ∈ Nₑₗₛₑ then |
| 9 | \| | \|_ fuse(nop, nₑₗₛₑ) |
| 10 | \| | n_{if} ← getLastRemainingNode({N_{if}}); |
| 11 | \|_{—} | nₑₗₛₑ ← getLastRemainingNode({Nₑₗₛₑ}); |
| 12 | for nᵢ such that i=0 to \|N\| do | |
| 13 | \| | if nᵢ is an eligible select operation ∈ Nₒₜₕₑᵣ, [symbol] |
| | \| | input₁(nᵢ), input₂(nᵢ) = m_{fused} ∈ M_{fused} then |
| 14 | \| | \|_ Eliminateₚₕᵢ(nᵢ); |

| | |
|---|---|
| | \|_{—} |
| 15 | Remove_Redundant_Arcs(E); |
| 16 | Prune_Predicate_Arcs(E); |

Proof of Correctness:

For nodes xₜ, yₜεyₜεN_{if} and x_{f}, y_{f}εNₑₗₛₑ, with partial order of xₜ<yₜ and x_{f}<y_{f}, meaning yₜ, y_{f} cannot be scheduled earlier than xₜ, x_{f}. An example of bad scheduling is shown by incorrect pairings 632 containing [symbol] xₜ, y_{f} [symbol] and 628 containing [symbol] yₜ, x_{f} [symbol] in FIG. 6D. Since the algorithm starts pairing from the terminating nodes with pair 620 containing [symbol] yₜ, y_{f} [symbol] of either path, and proceeds iteratively through the partial order forming another pair 612, [symbol] xₜ, x_{f} [symbol] , there is no possibility of breaking the partial order and obtaining an incorrect pairing. Time Complexity is O(n) where n=max(|N_{if}|, |Nₑₗₛₑ|)+|Nₒₜₕₑᵣ|. |Nₑₗₛₑ|)) for pairing operations and O(|Nₒₜₕₑᵣ|) for phi elimination.

Support for Nested Conditionals:

PSB provides maximum performance improvement when the number of operations in the conditional path is large. Hence, for nested conditionals, the formation of fused nodes is done for the outermost conditional block. The number of operations for the inner nests is typically small and hence is acceptable to be handled by partial predication (Han, et al., 2013) (preferred over full predication to alleviate the tight restrictions on mapping). The if-path and else-path operations of the fused nodes are inherently composed of their respective path's inner conditionals and their operations. FIG. 11 is an illustrative embodiment of an LLVM compiler heuristic 1100 in accordance with the present disclosure. In the embodiment shown, a DFG is input into the compiler at step 1104. Then at step 1108 the compiler begins to work through the DFG starting at the last node of each of the if-path and else-path to determine whether or not nodes exist at the same level of each path in step 1112 and, if so, then fusing the nodes at step 1116. This fusing process continues via loop 1120 until all nodes available for fusing have been fused. The compiler then proceeds to step 1124 to determine whether or not a phi or select operation may be removed and using incrementer step 1128 and evaluator step 1132 to step through any phi or select operations at each node of the DFG to evaluate whether or not the phi or select operation may be eliminated. Phi or select operations are eliminated as the compiler increments by step 1136; however, in other embodiments, removal of phi or select operations may proceed in a different order or by another process than simple incrementing and step through of each node of the fused DFG. For example, in some embodiments, it may be possible to remove phi or select operations prior to node fusing that occurs in step 1116 of the depicted embodiment. The DFG is then pruned and redundant arcs are removed at step 1140 and the fused and pruned DFG is output at step 1144. The output DFG at step 1144, at least in some embodiments, is then ready to have its nodes be mapped to individual PEs in a CGRA. This mapping may be performed by the compiler, LLVM or otherwise as is shown in the embodiment of FIG. 13 within compiler 1310 containing step 1318 for mapping paired operations on a CGRA and generating scheduled instructions. In some embodiments, either or both of the steps of mapping and generating the instructions within the compiler does not require issuance of an instructions to the CGRA and thus avoids use of clock cycles or processing power within the CGRA. The compiler in these embodiments merely performs a virtual mapping so that if a branch is true, the compiler has already determined which processing elements will perform the instructions according to the mapping that was conducted prior to instruction fetch.

FIG. 13 is a block diagram of one embodiment of the present disclosure. Some embodiments of the present methods (e.g., method 1300) comprise step 1301 receiving at least one function executed by a computer program. Some embodiments comprise resolving a branching condition within a CGRA, illustrated in FIG. 13 by the branch outcome 1303 being communicated by CGRA 1302 to instruction fetch unit (IFU) 1304. In some embodiments, the IFU uses the branch outcome to issue only instructions for the branch to be executed according to branch outcome 1303. The instructions issued by IFU 1304 are then executed by CGRA 1302 from the at least one path of the branch to be executed. In some embodiments, at least one path of the branch is false and the instructions associated with the false branch will not be fetched by IFU 1304 for execution within CGRA 1302. The IFU may selectively issue instructions from the instruction memory 1304 for at least one path to be executed by the CGRA 1302. Some embodiments comprise hardware components (e.g., connection 1303 may contain more than just branch outcome) communicating the branching condition outcome and a number of cycles required to execute the at least one path to the instruction fetch unit. Some embodiments comprise utilizing a delay slot after the step of resolving the branching condition outcome to communicate the branching condition outcome to the instruction fetch unit. In some embodiments, CGRA 1302 performs operations that are independent of the current branching condition outcome in the delay slot. Some embodiments comprise mapping operations to processing elements (e.g., PE 554 at time 502 in FIG. 5A has operations mapped to node 514) in the coarse grain reconfigurable array from both an if-path of the branching condition and an else-path of the branching condition. Some embodiments comprise pairing the mapped operations from the if-path and the else-path based on a common variable (e.g., node 518 in FIG. 5A). Some embodiments comprise pairing a no op instruction with an if-path instruction when the else-path contains fewer operations than the if-path (e.g., similar to node 510 in FIG. 5A pairing a no-op with an else-path instruction). Some embodiments comprise pairing a no op instruction with an else-path instruction when the if-path contains fewer operations than the else-path (e.g., node 510 in FIG. 5A). FIG. 13 illustrates that in some embodiments the pairing operations may be performed by a compiler 1310 at step 1314. Some embodiments comprise eliminating a select instruction or a phi operation based on the pairing by the common variable and based on the step of communicating which of the at least one paths of the branching condition is to be executed to the instruction fetch unit. This elimination step may also be performed by the compiler (e.g., 1310), as described above in relation to FIG. 11 at step 1136.

4. Experimental Results

A. PSB Achieves Lower II Compared to Existing Techniques to Accelerate Control Flow.

To evaluate the performance of PSB, CGRA has been modelled as an accelerator in the Gem5 system simulation framework (Binkert, et al., 2011), integrated with one embodiment of a PSB compiler technique as a separate pass in the LLVM compiler framework (Lattner & Adve, 2004). The DFG obtained after PSB transformation was mapped using REGIMap mapping algorithm (Hamzeh, et al., 2013) modified to accommodate the delay slot required for correct functioning. Computational loops with control flow were extracted from SPEC2006 (Henning, 2006), biobench (Albayraktaroglu, 2005) benchmarks after −O3 optimization in LLVM. The loops were mapped on a 4×4 torus interconnected CGRA with sufficient instruction and data memory. FIG. 9 shows plot 900 with the II 904 achieved by different techniques: partial predication scheme shown by fill 908, full predication scheme shown by fill 912, dual-issue predication scheme shown by fill 916, and one embodiment of the PSB scheme of the present disclosure shown by fill 920.

The full predication scheme (fill 912) presented in (Han et al., 2013) has the lowest performance due to the tight restriction on mapping of operations in the conditional path. Such operations must be mapped only to the PE in which the predicate value is available, which increases the schedule length and ultimately the II. Partial predication scheme (fill 908) performs better because it is devoid of such restrictions and the overhead here is the introduction of select operations. Even though the dual issue scheme (fill 916) (Han, et al., 2010) eliminates execution of unnecessary operations, it suffers from restriction in mapping due to overhead in communicating the predicate to all the merged nodes. The performance of one embodiment of the presently disclosed PSB compiler technique depends on the size of the if-then-else. For kernels in which the number of operations in the conditional path is more (51% of operations in tree, gapaling, gcc are in the conditional path) there was a very significant (up to 25% reduction in node size and 45% reduction in edge size on an average due to pairing of operations by PSB) improvement of II—an average of 62% better than other techniques. For benchmarks with smaller if-then-elses, the tested embodiment achieved a moderate reduction in II (11% in sphinx3, fasta, calculix). In these cases, the number of operations in the conditional path was (35%) which lead to a reduction in the DFG size of 15% and 23% reduction in node and edge size. Therefore, PSB is particularly well suited for loop kernels with relatively large number of operations in the conditional path but is effective for other sized loop kernels as well. By executing operations only from the path taken and eliminating the predicate communication overhead, the tested PSB embodiment overcame the inefficiencies associated with existing techniques, and achieved a performance improvement of 34.6%, 36% and 59.4% on an average compared to the state of the art dual issue scheme (Hamzeh, et al., 2014), partial predication scheme (Mahlke, et al., 1995) and State based Full Predication (SFP) scheme presented in Han, et al., 2013, respectively.

B. PSB Architecture Embodiments Area and Frequency

One modeled embodiment implemented the RTL model of a 4×4 CGRA including an IFU with torus interconnection. Since all PEs in this embodiment have symmetrical interconnections, a single designated PE was connected to the IFU in the PSB architecture. Other embodiment may contain more than one IFU or more than one PE connected to one or more IFUs. A mapping generated for a generic 4×4 CGRA template can be panned across the CGRA template so as to allocate the branch operation to the designated PE. This is not a restriction in mapping because the symmetry of interconnection. For multiple independent branches, predicates can be communicated to the designated PE through predicate network and then to the IFU. The RTL model embodiments were synthesized in 65 nm node using RTL compiler tool, functionally verified, and placed and routed using Cadence Encounter. Results are tabulated in Table I. The disclosed PSB architecture does not incur any significant hardware overhead.

TABLE 1
CGRA PLACE AND ROUTE RESULTS

| | Partial | Full | Dual | |
|---|---|---|---|---|
| CGRA | Predication | Predication | Issue | PSB |
| Area (sq. um) | 375708 | 384539 | 411248 | 384154 |
| Frequency (MHz) | 463 | 477 | 454 | 458 |

C. PSB Embodiments have Lower Energy Consumption

To evaluate energy consumption, the dynamic power for each type of PE operation (ALU, routing or IDLE) from (Kim & Lee, 2012) and scaled to fit their synthesized RTL was estimated. The power for an instruction fetch operation was modelled by a 2 kb configuration cache, in 65 nm node, from the cacti 5.3 tool (CACTI, 2008). The total energy spent in executing a kernel of each benchmark (partial predication, full predication, and dual-issue) was modelled as a function of the energy spent per PE per cycle depending upon the type of operation and the instruction fetch power. FIG. 10 shows relative energy consumption 1004 on the y-axis that the full predication (fill 1012) scheme presented in (Han, et al., 2013) has the highest energy consumption in spite of sleeping the PEs during the execution of the false path. This is mainly attributed to the higher II due to tight restrictions in mapping. Higher II translates to more instructions fetched and more PEs occupied for execution of the kernel leading to a corresponding increase in instruction fetch operations and PE static power. In dual issue scheme (fill 1016), there is an overhead (53% more power) in instruction fetch operation because the number of bits fetched per cycle is twice as much as compared to other techniques. Moreover, this is worsened by the higher II achieved due to predicate communication overhead, increasing the overall number of instruction bits fetched and hence the higher energy consumption per kernel. Even though partial predication scheme (fill 1012) executes unnecessary operations, the energy expenditure is compensated to some extent by achieving lower II compared to the SFP and the dual issue scheme. PSB avoids fetching and executing unnecessary instructions and often achieves the lowest II. Because embodiments of PSB techniques have lower IIs, the presented PSB techniques may have lower energy consumption than other techniques. Experimental results show that PSB has 52.1%, 53.1% and 33.53% lower energy consumption on an average compared to state of the art dual issue scheme, full predication, and partial predication schemes, respectively.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### D. Other Illustrative Embodiments

Some embodiments of the present methods comprise: receiving at least one function executed by a computer program; resolving a branching condition to produce an outcome wherein at least one path of the branch is to be executed by a coarse grain reconfigurable array (e.g., CGRA 1204 in FIG. 12) and at least one path of the branch is false; executing the branch condition in at least one processing element of the Coarse Grain Reconfigurable Array and communicating the branch outcome to the Instruction Fetch Unit (e.g., IFU 1208); and selectively issuing instructions from the instruction memory (e.g., 1216) for at least one path to be executed by the CGRA. Some embodiments comprise hardware components, such as one PE within the CGRA, communicating the branching condition outcome and a number of cycles required to execute the at least one path to the instruction fetch unit. Relational diagram 1200 in FIG. 12 illustrates how in some embodiments, the branch outcome may be performed by one or more PEs within CGRA 1204 and communicated to IFU 1208 via connection 1212. Some embodiments comprise utilizing a delay slot after the step of resolving the branching condition outcome to communicate the branching condition outcome to the instruction fetch unit. The IFU 1208 may fetch and issue instructions from instruction memory 1216, issuing them to CGRA 1204. Some embodiments comprise performing operations that are independent of the current branching condition outcome in the delay slot. This may be performed by compiler 1220, which in some embodiments will coordinate instructions from memory 1216 and data from memory 1224. Some embodiments comprise mapping operations to processing elements in the coarse grain reconfigurable array from both an if-path of the branching condition and an else-path of the branching condition. Again, the compiler 1220 may perform this mapping step, using DFGs or some other representation relating instructions from the different paths of a conditional statement. Some embodiments comprise pairing the mapped operations from the if-path and the else-path based on a common variable. Some embodiments comprise pairing a no op instruction with an if-path instruction when the else-path contains fewer operations than the if-path. Some embodiments comprise pairing a no op instruction with an else-path instruction when the if-path contains fewer operations than the else-path. Some embodiments comprise eliminating a select instruction or a phi operation based on the pairing by the common variable and based on the step of communicating which of the at least one paths of the branching condition is to be executed to the instruction fetch unit. The above steps may be performed by the compiler and, while the above is framed in the context of if-then-else conditionals, some embodiments may perform the mapping described herein using other forms of conditional statements.

Some embodiments of the present apparatuses comprise a memory; and a processor coupled to the memory, wherein the processor is configured to execute the steps of: receiving at least one function (e.g., loop kernel) executed by a computer program; resolving a branching condition to produce an outcome wherein at least one path of the branch is to be executed by a coarse grain reconfigurable array and at least one path of the branch is false; executing the branch condition in at least one processing element of the Coarse Grain Reconfigurable Array and communicating the branch outcome to the Instruction Fetch Unit; and selectively issuing instructions from the instruction memory for the at least one path to be executed. In some embodiments, the processor is further configured to execute the step of communicating the branching condition outcome and a number of cycles required to execute the at least one paths to the instruction fetch unit by minimum delay circuit components. In some embodiments, the processor is further configured to execute the step of utilizing a delay slot after the step of resolving the branching condition outcome to communicate the branching condition outcome to the instruction fetch unit. In some embodiments, the processor is further configured to execute the step of performing operations that are independent of the branching condition outcome in the delay slot. In some embodiments, the processor is further configured to execute the step of mapping operations to processing elements in the coarse grain reconfigurable array from both an if-path of the branching condition and an else-path of the branching condition. In some embodiments, the processor is further configured to execute the step of pairing the mapped operations from the if-path and the else-path based on a common variable. In some embodiments, the processor is further configured to execute the step of pairing a no op instruction with an if-path instruction when the else-path contains fewer operations than the if-path. In some embodiments, the processor is further configured to execute the step of pairing a no op instruction with an else-path instruction when the if-path contains few operations than the else-path. In some embodiments, the processor is further configured to execute the step of eliminating a select instruction or a phi operation based on the pairing by the common variable and based on the step of communicating which of the at least one paths of the branching condition is to be executed to the instruction fetch unit.

Some embodiments of the present methods comprise: receiving at least one function (e.g., loop kernel) executed by a computer program, wherein the function includes a branching condition; mapping at least two potential paths of the branching condition to at least one processing element in a coarse grain reconfigurable array by a compiler; resolving the branching condition to produce an outcome wherein at least one path of the branch is to be executed by a coarse grain reconfigurable array and at least one path of the branch is false; executing the branch condition in at least one processing element of the Coarse Grain Reconfigurable Array and communicating the branch outcome to the Instruction Fetch Unit; and selectively issuing instructions from the instruction memory for the at least one path to be executed.

Some embodiments of the present apparatuses comprise: a coarse grain reconfigurable array comprising at least two processing elements; an instruction fetch unit; at least one processing element configured to communicate a branch outcome to the instruction fetch unit; the branch outcome comprising at least a path to be taken; the instruction fetch unit further configured to issue instructions for the path taken. In some embodiments, at least one processing element (which also evaluates the branch condition) is configured to communicate a number of cycles required to execute the path to be taken to the instruction fetch unit.

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### REFERENCES

The following references, to the extent that they provide exemplary procedural or other details supplementary to those set forth herein, are specifically incorporated herein by reference.
Albayraktaroglu, “BioBench: A Benchmark Suite of Bioinformatics Applications,” in ISPASS 2005, 2-9, 2005.
Betkaoui, “Comparing performance and energy efficiency of FPGAs and GPUs for high productivity computing,” in FPT. 94-101, 2010.
Binkert, et. al, “The Gem5 Simulator,” SIGARCH Comput. Archit. News. 39(2):1-7, 2011.
Bouwens, et. al, “Architecture Enhancements for the ADRES Coarse-Grained Reconfigurable Array,” in Proc. HiPEAC. 66-81, 2008.
CACTI, “HP Laboratories Palo Alto, CACTI 5.3,” 2008.
Carroll, et. al, “Designing a Coarsegrained Reconfigurable Architecture for Power Efficiency, Department of Energy NA-22 University Information Technical Interchange Review Meeting,” Tech. Rep., 2007.
Chang & Choi, “Mapping control intensive kernels onto coarse-grained reconfigurable array architecture,” in ISOCC '08, pp. 1-362-1-365, 2008.
Che, Li, & Sheaffer, “Accelerating Compute-Intensive Applications with GPUs and FPGAs,” in SASP. 101-107, 2008.
Chung & Milder, “Single-Chip Heterogeneous Computing: Does the Future Include Custom Logic, FPGAs, and GPGPUs?” in MICRO. 225-236, 2010.
De Sutter, Handbook of Signal Processing Systems, 2nd ed. Springer, ch. Coarse-Grained Reconfigurable Array Architectures, pp. 553-592, 2013.
Hamzeh, Shrivastava, & Vrudhula, “Branch-Aware Loop Mapping on CGRAs,” ser. DAC '14. ACM, pp. 107:1-107:6, 2014.
Hamzeh, Shrivastava, & Vrudhula, “REGIMap: Registeraware application mapping on Coarse-Grained Reconfigurable Architectures (CGRAs),” in DAC 2013, 1-10, 2013.
Han, Ahn, & Choi, “Power-Efficient Predication Techniques for Acceleration of Control Flow Execution on CGRA,” ACM Trans. Archit. Code Optim. 10(2):8:1-8:25, 2013.
Han, et. al, “Acceleration of control flow on CGRA using advanced predicated execution,” in FPT 2010, 429-432, 2010.
Han, et. al, “Compiling control-intensive loops for CGRAs with state-based full predication,” in DATE 2013, 1579-1582, 2013.
Henning, “SPEC CPU2006 Benchmark Descriptions,” SIGARCH Comput. Archit. News. 34(4):1-17, 2006.
Johnson & Pingali, “Dependence-based Program Analysis,” SIGPLAN Not. 28(6):78-89, 1993.
Kim & Lee, “Improving Performance of Nested Loops on Reconfigurable Array Processors,” ACM Trans. Archit. Code Optim. 8(4): 32:1-32:23, 2012.
Lattner & Adve, “LLVM: A Compilation Framework for Lifelong Program Analysis & Transformation,” in CGO′04, 2004.
Mahlke & Lin, “Effective Compiler Support For Predicated Execution Using The Hyperblock,” in MICRO 25, 45-54, 1992.
Mahlke, “A comparison of full and partial predicated execution support for ILP processors,” in Computer Architecture Symposium. 138-149, 1995.
Rau, “Iterative Modulo Scheduling: An Algorithm for Software Pipelining Loops,” ser. MICRO 27. ACM, 1994, 63-74, 1994.
Theodoridis, “A survey of coarse-grain reconfigurable architectures and cad tools,” in Fine- and Coarse-Grain Reconfigurable Computing, S. E. Vassiliadis, Ed. Springer, 89-149, 2007.

What is claimed is:

1. A method, comprising:
receiving at least one function executed by a computer program;
resolving a branching condition to produce an outcome wherein at least one path of the branch is to be executed by a coarse grain reconfigurable array and at least one path of the branch is false;
executing the branch condition in at least one processing element of the Coarse Grain Reconfigurable Array and communicating the branch outcome to an Instruction Fetch Unit; and
selectively issuing instructions from an instruction memory for at least one path to be executed.

2. The method of claim 1, further comprising communicating the branching condition outcome and a number of cycles required to execute the at least one paths to the instruction fetch unit by at least one processing element of the Coarse-grain Reconfigurable Array

3. The method of claim 1, further comprising utilizing a delay slot after the step of resolving the branching condition outcome to communicate the branching condition outcome to the instruction fetch unit.

4. The method of claim 3, further comprising performing operations that are independent of the branching condition outcome in the delay slot.

5. The method of any of claim 1, further comprising mapping operations to processing elements in the coarse grain reconfigurable array from both an if-path of the branching condition and an else-path of the branching condition with a compiler.

6. The method of claim 5, further comprising pairing the mapped operations from the if-path and the else-path based on a common variable.

7. The method of claim 6, further comprising pairing a no op instruction with an if-path instruction when the else-path contains fewer operations than the if-path.

8. The method of claim 6, further comprising pairing a no op instruction with an else-path instruction when the if-path contains few operations than the else-path.

9. The method of claim 8, further comprising eliminating a select instruction or a phi operation based on the pairing by the common variable and based on the step of communicating which of the at least one paths of the branching condition is to be executed to the instruction fetch unit.

10. A computer program product, comprising:
a non-transitory computer readable medium comprising code for performing the steps of:
receiving at least one function executed by a computer program;
resolving a branching condition to produce an outcome wherein at least one path of the branch is to be executed by a coarse grain reconfigurable array and at least one path of the branch is false;
executing the branch condition in at least one processing element of the Coarse Grain Reconfigurable Array and communicating the branch outcome to an Instruction Fetch Unit; and
selectively issuing instructions from an instruction memory for at least one path to be executed.

11. The computer program product of claim 10, wherein the non-transitory computer readable medium further comprises code for performing the step of communicating the branching condition outcome and a number of cycles required to execute the at least one paths to the instruction fetch unit by at least one processing element of the Coarse-grain Reconfigurable Array

12. The computer program product of claim 10, wherein the non-transitory computer readable medium further comprises code for performing the step of utilizing a delay slot after the step of resolving the branching condition outcome to communicate the branching condition outcome to the instruction fetch unit.

13. The computer program product of claim 12, wherein the non-transitory computer readable medium further comprises code for performing the step of performing operations that are independent of the branching condition outcome in the delay slot.

14. The computer program product of any of claim 10, wherein the non-transitory computer readable medium further comprises code for performing the step of mapping operations to processing elements in the coarse grain reconfigurable array from both an if-path of the branching condition and an else-path of the branching condition.

15. The computer program product of claim 14, wherein the non-transitory computer readable medium further comprises code for performing the step of pairing the mapped operations from the if-path and the else-path based on a common variable.

16. The computer program product of claim 15, wherein the non-transitory computer readable medium further comprises code for performing the step of pairing a no op instruction with an if-path instruction when the else-path contains fewer operations than the if-path.

17. The computer program product of claim 15, wherein the non-transitory computer readable medium further comprises code for performing the step of pairing a no op instruction with an else-path instruction when the if-path contains few operations than the else-path.

18. The computer program product of claim 17, wherein the non-transitory computer readable medium further comprises code for performing the step of eliminating a select instruction or a phi operation based on the pairing by the common variable and based on the step of communicating which of the at least one paths of the branching condition is to be executed to the instruction fetch unit.

19. An apparatus, comprising:
a memory; and
a processor coupled to the memory, wherein the processor is configured to execute the steps of:
receiving at least one function executed by a computer program;
resolving a branching condition to produce an outcome wherein at least one path of the branch is to be executed by a coarse grain reconfigurable array and at least one path of the branch is false;
executing the branch condition in at least one processing element of the Coarse Grain Reconfigurable Array and communicating the branch outcome to an Instruction Fetch Unit; and
selectively issuing instructions from an instruction memory for at least one path to be executed.

20. The apparatus of claim 19, wherein the processor is further configured to execute the step of communicating the branching condition outcome and a number of cycles required to execute the at least one paths to the instruction fetch unit by at least one processing element of the coarse-grain reconfigurable array.

21. The apparatus of claim 19, wherein the processor is further configured to execute the step of utilizing a delay slot after the step of resolving the branching condition outcome to communicate the branching condition outcome to the instruction fetch unit.

22. The apparatus of claim 21, wherein the processor is further configured to execute the step of performing operations that are independent of the branching condition outcome in the delay slot.

23. The apparatus of any of claim 19, wherein the processor is further configured to execute the step of mapping operations to processing elements in the coarse grain reconfigurable array from both an if-path of the branching condition and an else-path of the branching condition.

24. The apparatus of claim 23, wherein the processor is further configured to execute the step of pairing the mapped operations from the if-path and the else-path based on a common variable.

25. The apparatus of claim 24, wherein the processor is further configured to execute the step of pairing a no op instruction with an if-path instruction when the else-path contains fewer operations than the if-path.

26. The apparatus of claim 24, wherein the processor is further configured to execute the step of pairing a no op instruction with an else-path instruction when the if-path contains few operations than the else-path.

27. The apparatus of claim 26, wherein the processor is further configured to execute the step of eliminating a select instruction or a phi operation based on the pairing by the common variable and based on the step of communicating which of the at least one paths of the branching condition is to be executed to the instruction fetch unit.

28. A method, comprising:
receiving at least one function executed by a computer program, wherein the function includes a branching condition;
mapping at least two potential paths of the branching condition to at least one processing element in a coarse grain reconfigurable array by a compiler;
resolving the branching condition to produce an outcome wherein at least one path of the branch is to be executed by a coarse grain reconfigurable array and at least one path of the branch is false;
executing the branch condition in at least one processing element of the Coarse Grain Reconfigurable Array and communicating the branch outcome to an Instruction Fetch Unit; and
selectively issuing instructions from an instruction memory for at least one path to be executed.

29. An apparatus, comprising:
a coarse grain reconfigurable array comprising at least two processing elements;
an instruction fetch unit;
at least one processing element of the Coarse Grain Reconfigurable Array configured to communicate a branch outcome from a function to be executed to the instruction fetch unit;
the branch outcome comprising at least a path to be taken;
the instruction fetch unit further configured to issue instructions for the path to be taken.

30. The apparatus of claim 29 where at least one processing element of the Coarse Grain Reconfigurable Array is further configured to communicate a number of cycles required to execute the path to be taken to the instruction fetch unit.
